(19) United States
(12) Patent Application Publication
(10) Pub. No.: US 2025/0303212 A1
(43) Pub. Date: Oct. 2, 2025

(54) Multichannel Deactivation of Noxious Chemical and Biological Agents

(71) Applicant: Seton Hall University, South Orange, NJ (US)

(72) Inventors: Sergiu M. Gorun, South Orange, NJ (US); Marius Pelmus, South Orange, NJ (US); Alexander Y. Fadeev, South Orange, NJ (US); James E. Hanson, South Orange, NJ (US)

(73) Assignee: Seton Hall University, South Orange, NJ (US)

(21) Appl. No.: 19/092,444

(22) Filed: Mar. 27, 2025

Related U.S. Application Data
(60) Provisional application No. 63/570,556, filed on Mar. 27, 2024.

(51) Int. Cl. A62D 3/30; A62D 3/17; A62D 101/02; A62D 101/28; B01J 23/14; B01J 37/02

(52) U.S. Cl. CPC A62D 3/30; A62D 3/17; B01J 23/14; B01J 37/0215; A62D 2101/02; A62D 2101/28; A62D 2203/02

(57) ABSTRACT

Germanium-doped titania semiconductors, which are capable of photocatalyzed electron transfer are coated with electronic deficient fluorinated phthalocyanines capable of energy transfer. The combination of these pathways results in a broad spectrum photocatalyst useful for deactivating harmful chemical and biological agents.

### CROSS-REFERENCE TO RELATED APPLICATIONS

The application claims the benefit of the filing date of U.S. Provisional Patent Application No. 63/570,556 filed Mar. 27, 2024, the disclosure of which is hereby incorporated herein by reference.

### TECHNICAL FIELD

Disclosed is a composition and method for detoxification of chemical warfare agents, CWAs. The composition may include a solid-state support that may be capable to degrade CWAs hydrolytically, via electron transfer and other mechanisms, but without transferring energy, and a material able to absorb light and transfer its energy to molecular oxygen present in air. More particularly, disclosed is a composition and method using germanium-doped titania semiconductors that are capable of both photocatalyzed electron transfer and hydrolysis, coated with robust, electronic deficient fluorinated phthalocyanines (henceforth phthalocyanines are abbreviated Pcs, fluorinated phthalocyanines are abbreviated FₙPcs) capable of energy transfer. The combination of these pathways results in a broad spectrum catalyst useful for deactivating harmful chemical and biological agents.

### BACKGROUND

Since sulfur mustard (HD) was first used in World War I, significant efforts have been made in materials and methods development for the adsorption and detoxification of different classes of chemical warfare agents (CWAs). Other CWAs include nerve agents, a class of chemical warfare agents composed of reactive organophosphates (e.g., Soman (GD) and VX). The development and use of materials for the detoxification of CWAs dates back to World War I where bleaching powder was first used to detoxify HD. Solutions of bleach or basic salts, such as NaOH and KOH were also used to detoxify G-agents (organophosphate nerve agents tabun (GA), sarin (GB), soman (GD), and cyclosarin (GF)), and, later, V-agents, such as VX.

Unfortunately, the quantity of bleach required to detoxify the agents, combined with its corrosive properties and loss of activity with long term storage, make the use of bleaching solutions impractical. The first solid adsorbent material used for adsorption and detoxification, M29, was introduced in 1989 as a kit contains fiber pads that are filled with a high surface area carbonaceous materials for adsorption, in addition to strongly acidic (cation) and basic (anion) exchange resins to promote hydrolysis of the adsorbed agents. Although this material is an effective adsorbent for G-agents and VX, only GD is actually hydrolyzed and detoxified with a half-life of 30 hours.

Significant research efforts, primarily beginning in the late 1990s, have been focused on the development of solid adsorbent materials that not only adsorb, but also quickly and efficiently hydrolyze and detoxify nerve agents such as GD, GB and VX. A handful of metal oxides such as MgO, CaO, and Al₂O₃ show reactivity towards nerve agents; however, they suffer from problems with air and water stability, as well as poisoning (inhibition by reaction products).

Considering the importance of efficiency and safety of detoxification processes, catalytic degradations have been examined as an approach for fast and complete detoxification of CWAs. To date, a variety of catalysts have been shown to be active for the degradation of nerve agents and sulfur mustard. However, many such catalytic materials have significant drawbacks such as thermal and chemical instability, as well as other limitations. For example, many compositions are unsuitable for use on protective clothing for detoxification the agents.

Therefore, there still exists a critical need for a novel composition that allows for effective treatment of CWA and without adverse effects. In addition, there is a need for a composition and methodology to cost-effectively provide high quality protective materials that are able to detoxify such agents.

### SUMMARY OF THE INVENTION

Compared to the above prior attempts, the presently disclosed composition and method help solve the problems of current state of the art, meet the above requirements, and provide many more benefits.

The present invention relates to germanium-doped titania semiconductors which are capable of both hydrolysis and photocatalyzed electron transfer, and which are coated with robust, electronic deficient fluorinated phthalocyanines capable of energy transfer and reactivity enhancement. The combination of these pathways results in a broad spectrum photocatalyst or resulting hybrid material(s) useful for deactivating harmful chemical and/or biological agents. For example the photocatalyst or resulting hybrid material(s) may be coated on fabric selected from a group consisting of nonwoven fabric, cotton, polyester, woven fabric, dacron, nylon, Kevlar, and any combination thereof.

Titania is doped with GeO₂ using various solid-state techniques, followed by the application of a solution of the fluorophthalocyanine and the drying of the resulting hybrid materials by removing the solvent. Chemical and biological agent simulants, dissolved in an appropriate solvent, or directly applied on the hybrid materials, illuminated with white light, show a reduction in concentration, as quantified using standard analytical techniques.

In another aspect, fumed aeroxide P25, particle size ˜20 nm, surface area˜50 m²/g suspended in water, or titania gel Tronox™, particle size ˜100 nm, surface area˜10 m²/g were reacted with an aqueous solution of Ge(OH)₄ at pH˜4. The content of germania, GeO₂, in Ti(Ge)O₂ is at the level of 1-5% by mass, but higher concentration can be obtained as needed. The germania-coated titania were loaded with Zinc (II) 1,4,8,11,15,18,22,25-octafluoro-2,3,9,10,16,17,23,24-octakisperfluoro (isopropyl) phthalocyanine, F₆₄PcZn, via precipitated deposition (˜3% loadings) yielding F₆₄PcZn/P25 Ti(Ge)O₂ and F₆₄PcZn/Tronox Ti(Ge)O₂. The catalysts were evaluated for the decomposition of chloroethyl ethyl sulfide, CEES, an HD simulant. The half-life of CEES photodegradations is 10 min for F₆₄PcZn/P25 Ti(Ge)O₂, and 11 min for F₆₄PcZn/Tronox Ti(Ge)O₂. Tronox™ is a producer of titanium dioxide and other materials.

The above objects and advantages are met by the present invention. In addition, the above, and yet other objects and advantages of the present invention will become apparent from the hereinafter set forth. Brief Description of the Drawings, Detailed Description of the Invention and claims appended herewith. These features and other features are described and shown in the following drawings and detailed description.

### BRIEF DESCRIPTION OF FIGURES

So that those having ordinary skill in the art will have a better understanding of how to make and use the disclosed composition and methods, reference is made to the accompanying figures wherein:

FIG. 1 is a schematic of the photochemical basic mechanism of reactivity of the proposed invention; the Oxygen that acquired energy, termed singlet oxygen, decays to produce radicals and other reactive oxygen species (ROS) that destroy the noxious agents

FIG. 2a-2g. Structural progression of light-absorbing structures from Chlorophyll to fluorinated F₁₆PcM (II) and F₆₄PcM (II), M stands for a Metal dication.

FIG. 3a illustrates oxidic supports used in the present invention, and FIG. 3b illustrates the encapsulation, “E”, and capping “C” of a trapped Pc using tetraethoxysilane (TEOS). A semipermeable silicate network that prevents Pc leaching is produced.

FIG. 4a is a graph illustrating the relationship between temperature and weight percentage for TGA pure phthalocyanines, and FIG. 4b is a graph illustrating the relationship between temperature and weight percentage for TGA phthalocyanines supported on P25 of the proposed invention; and

FIG. 5 is a graph illustrating binding energy of the Zn 2p orbital using the principles of the proposed invention.

### DETAILED DESCRIPTION

The present disclosure is directed to a new composition, a process, and novel strategy for solutions to enable the Warfighter to deter, prevent, protect against, mitigate, and respond to Chemical and Biological (CBN) threats and effects that are needed. A particularly desired solution is the invention of self-detoxifying technologies, which is a wearable protective material that does not require additional chemicals, often harmful, for example bleach, to assist in the detoxification effect.

The use of the terms “a,” “an,” “the,” and similar referents in the context of describing the present invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Use of the term “about” is intended to describe values either above or below the stated value in a range of approximately ±10%; in other embodiments, the values may range in value above or below the stated value in a range of approximately ±5%; in other embodiments, the values may range in value above or below the stated value in a range of approximately ±2%; in other embodiments, the values may range in value above or below the stated value in a range of approximately ±1%. The preceding ranges are intended to be made clear by context, and no further limitation is implied. The use of any and all examples, or exemplary language (e.g., “such as”) provided herein, is intended merely to better illuminate the invention, and does not pose a limitation on the scope of the invention unless otherwise stated. No language in the specification should be construed as indicating any non-claimed element as essential to the practice of the invention.

The core of the intended self-detoxifying reactivity approach is to construct materials that transfer electrons and hydrolyze chemical bonds, while also harvesting light and injecting its energy into oxygen from air to generate reactive oxygen species (ROS). ROS detoxify agents by attacking them chemically. The C—F bonds of the materials that generate ROS will protect them from self-destruction. The prototype is constructed by depositing a photosensitizer from the class phthalocyanines, Pc, on a support. The basic mechanism of photo reactivity is shown in FIG. 1. The energy of light is transferred by the photosensitizer to ground-state ³O₂ from air to generate reactive singlet oxygen, 102, in a process remarkably similar to the established photodynamic therapy to treat cancers.

FIG. 1 illustrates the photodynamic generation of ROS: ground-state, singlet ¹Pc₀ absorbs light to yield an excited state: ¹Pc₀+hν→¹Pc₁, which becomes a triplet ³Pc₁ via intersystem crossing, IC, ¹Pc₁→³Pc₁. The energy-reach ³Pc₁ transfers its energy to ground-state, triplet ³O₂ to generate ¹O₂ and regenerate ¹Pc₀: ³Pc₁+³O₂→¹Pc₁+¹O₂, to complete the catalytic cycle. In summary ¹O₂→ROS→degradation of noxious chemicals.

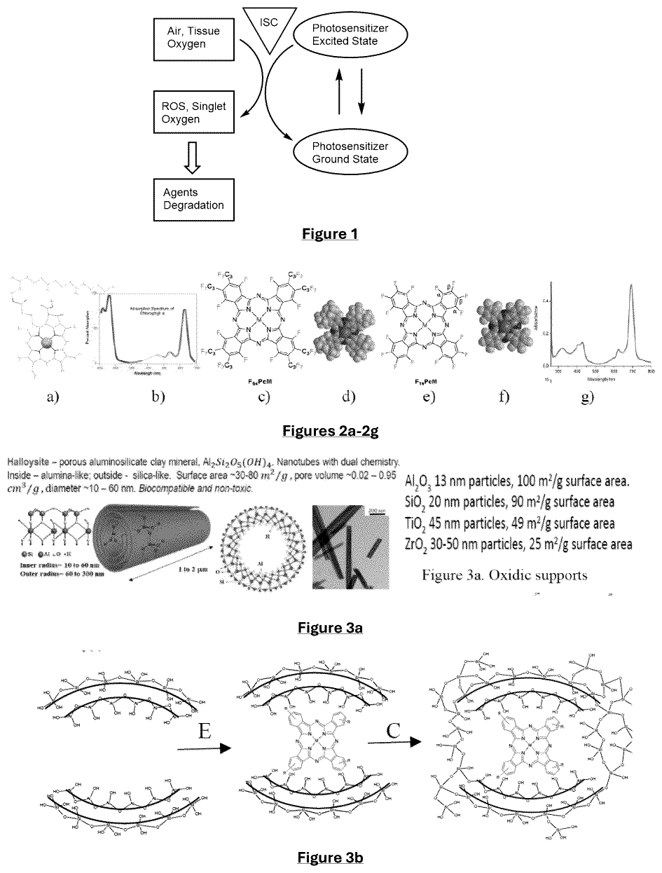

FIGS. 2a-2g Structural progression from Chlorophyll to fluorinated F₁₆PcM (II) and F₆₄PcM (II), M stands for a Metal dication. Color code: F, green; N, blue, C, gray. a) Chlorophyll a; M=Mg is shown as a sphere; b) UV-Vis spectrum of Chlorophyll a; c) structural formula of F₆₄PcM (II) exhibiting iso-perfluoroalkyl and aromatic F groups, M=Zn; d) X-ray structure of F₆₄PcM (II), M=Zn; e) structural formula of F₁₆PcM (II); f) X-ray structure of F₁₆PcM (II); g) UV-Vis spectrum of F₁₆PcM (II), M=Zn.

The HOMO-LUMO, like in chlorophyll, are located on the organic macrocycle. Fluorination hinders molecular electron loss, imparts thermal stability to ˜300° C., and chemical resistance. To complete self-detoxifying reactivity, a simultaneous reactivity pathways imparted by the oxidic supports is introduced. The supports and Pc encapsulation in metal-inorganic frameworks strategy are shown in FIGS. 3a and 3b, respectively.

The panchromaticity advantage. TiO₂, the semiconductor solid-state support of the fluorinated photosensitizer yields electron-hole pairs under illumination, and abstract electrons from agents leading to their destruction. The activity of TiO₂ is well known. The electron-transfer detoxifying reactivity channel complements the energy-transfer one supported by the Pc. Importantly, the absorbance in the UV-Vis region of the Pc, 600-800 nm, which dominates its spectrum, FIG. 2g, does not interfere with the UV region necessary for TiO₂ activation. Thus, the entire Solar spectrum is utilized more efficiently, leading to panchromatic self-detoxification.

The catalyzed hydrolytic advantage. Basic metal oxides, BMO, for example alumina Al₂O₃, and zirconia, ZrO₂, catalyze the hydrolytic degradation of P-based agents, less so the S-based ones. The BMOs use no light for their reactivity. Consequently, their use as supports for result in a dual hydrolytic-oxidative reactivity combination, ultimately yielding a material that should be capable of broad self-detoxification against HD, VX and GD, and thus defense against attacks that use mixtures of agents.

It should be pointed that the proposed inorganic supports are nanoscale metal-inorganic frameworks, without the diffusion and other issues of metal-organic framework, and exhibiting relatively favorable resistance to aggressive chemical agents such as ROS, which perform detoxification. The nano dimensions ensures high surface areas.

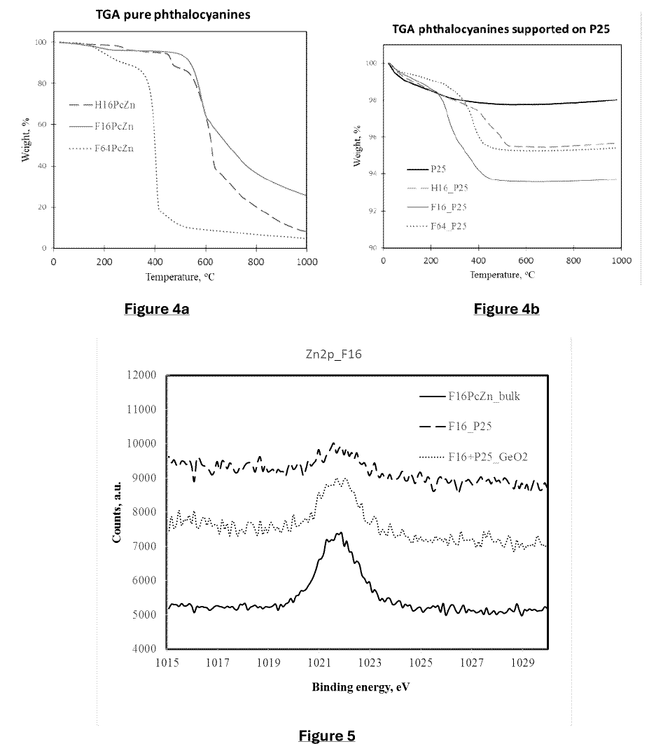

As shown in FIG. 4a and FIG. 4b the composition of matter, FₙPcMetal/Ti(Ge)O₂ (“/” stands for “coated on”) is based on FₙPcMetal/TiO₂, with dopant GeO₂ providing additional modifications. There are specific interactions between the surface of the bulk TiO₂ and the FₙPcMetal. Thermogravimetric analyses results obtained under inert Nitrogen for FₙPcMetal/TiO₂ vs. bulk, pure FₙPcMetal, n=16 and 64, Metal=Zinc had data that show a surprising result: there is a lowering of the weight-loss temperature of about 50 C for n=64, but for n=16 the temperature decreases by over 200° C. These results point toward specific interactions that rule out a simple physical mixture of the organic and inorganic support, thus the formation of a new phase.

As shown in FIG. 5, the Zn2p signal observed via X-ray photoelectron spectroscopy for a) bulk F₁₆PcZn, b) F₁₆PcZn/TiO₂, and c) F₁₆PcZn/Ti(Ge)O₂. The Ge dopant does not significantly alter the host structure.

The reactivity of the materials of the present invention is of interest, as evaluated for the degradation of CEES, an HD simulant. Thus, the ability of the bare oxides and dopes oxides coated with a Pc was compared. The half-lives of degradation of CEES using bare P25 TiO₂, Tronox and GeO₂ were 173, 105 and 72 minutes, respectively. On the other hand, F₆₄PcZn/P25 Ti(Ge)O₂ and F₆₄PcZn/Tronox (Ge) O₂ produced half-lives of degradation of CEES of 10 and 11 minutes, respectively, an acceleration of about one order of magnitude under otherwise identical conditions.

While in the foregoing specification the present invention has been described in relation to certain embodiments thereof, and many details have been put forth for the purposes of illustration, it will be apparent to those skilled in the art that the invention is susceptible to additional embodiments and that certain of the details described herein can be varied considerably without departing from the basic principles of the invention.

The present invention may be embodied in other specific forms without departing from the spirit or essential attributes thereof, and, accordingly, reference should be made to the appended claims, rather than to the foregoing specification, as indicating the scope of the invention.

Although the invention herein has been described with reference to embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A composition for detoxification of chemical war agents, comprising:
an effective amount of titania doped with an effective amount of GeO₂ using a solid-state technique; and
an amount of solution of a fluorophthalocyanine applied thereto to form a catalyst.

2. The composition of claim 1 wherein the catalyst composition is at least F₆₄PcZn/P25 Ti(Ge)O₂ or F₆₄PcZn/Ti(Ge)O₂.

3. The composition of claim 2, wherein decomposition of chloroethyl ethyl sulfide (CEES) with the catalyst results in a half-life of CEES photodegradations for about 10 min for F₆₄PcZn/P25 Ti(Ge)O₂, and about 11 min for F₆₄PcZn/Ti(Ge)O₂.

4. A process for making a composition for detoxification of chemical war agents, comprising:
doping titania with GeO₂ using a solid-state technique;
applying a solution of a solvent of fluorophthalocyanine; and
drying of a resulting hybrid material by removing the solvent.

5. The process of claim 4 further comprising:
dissolving chemical and biological agents, in a solvent directly deposited on the resulting hybrid material; and
illuminating the resulting hybrid materials with white light for reduction in concentration of the agents.

6. The process of claim 4, wherein the resulting hybrid material is coated on fabric selected from a group consisting of nonwoven fabric, cotton, polyester, woven fabric, dacron, nylon, Kevlar, and any combination thereof.

7. The process of claim 4 wherein the doping further comprises:
using a fumed aeroxide P25 having a particle size of about 20 nm, and a surface area of about 50 m²/g suspended in water, or a titania gel having a particle size of about 100 nm and a surface area of about 10 m²/g; and
reacting the resulting hybrid material with an aqueous solution of Ge(OH) 4 at about a pH4.

8. The process of claim 4 wherein, germania, GeO₂, in Ti(Ge)O₂ is at the level of about 1-5% by mass.

9. The process of claim 4, further comprises loading a germania-coated titania with Zinc (II) 1,4,8,11,15,18,22,25-octafluoro-2,3,9,10,16,17,23,24-octakisperfluoro (isopropyl) phthalocyanine, F₆₄PcZn, via precipitated deposition of about 3% loading.

10. The process of claim 4, wherein the hybrid material includes F₆₄PcZn/P25 Ti(Ge)O₂, F₆₄PcZn/Ti(Ge)O₂, or a combination thereof.

11. A process for making a composition for detoxification of chemical war agents, comprising:
doping titania with GeO₂;
applying a solution of a solvent of fluorophthalocyanine to form FₙPcMetal/Ti(Ge)O₂ or FₙPcMetal/P25 Ti(Ge)O₂, wherein “/” stands for “coated on,” and the Metal is Zn or a diamagnetic material; and n is 16 or 64, and
drying of a resulting hybrid material by removing the solvent, wherein the resulting hybrid material is a photocatalyst.

12. The process of claim 11, further comprises coating the photocatalyst on fabric selected from a group consisting of nonwoven fabric, cotton, polyester, woven fabric, dacron, nylon, Kevlar, and any combination thereof.

13. The process of claim 12, further comprises deactivating a chemical agent, biological agent, or combination thereof with the photocatalyst.

14. The process of claim 13, wherein the chemical agent, biological agent is chloroethyl ethyl sulfide (CEES).

15. The process of claim 14, wherein a half-life of CEES photodegradations is about 10 min for F₆₄PcZn/P25 Ti(Ge)O₂, and about 11 min for F₆₄PcZn/Ti(Ge)O₂.

16. The process of claim 11, wherein when the Metal=zinc (Zn) and n is 64 there is a lowering of the weight-loss temperature of about 50 C; and when the Metal=zinc (Zn) and n is 16 there is a weight-loss temperature of over 200 C.

17. The process of claim 11, wherein a content of germania, GeO₂, in Ti(Ge)O₂ is at the level of 1-5% by mass.

18. The process of claim 11, wherein the solvent of fluorophthalocyanine is Zinc (II) 1,4,8,11,15,18,22,25-octafluoro-2,3,9,10,16,17,23,24-octakisperfluoro (isopropyl) phthalocyanine.

19. The process of claim 11, wherein the doping further comprises using either a fumed aeroxide P25, or a titania gel to react with an aqueous solution of Ge(OH) 4 at about a pH 4.

20. The process of claim 11, wherein the fumed aeroxide P25 has particle size of about 20 nm and surface area of about 50 m²/g suspended in water; and the titania gel has particle size of about 100 nm and a surface area of about 10 m²/g.
